(19) United States
(12) Patent Application Publication
(10) Pub. No.: US 2011/0115326 A1
(43) Pub. Date: May 19, 2011

(54) ELECTRICAL MACHINES

(75) Inventors: Richard Edward Clark, Sheffield (GB); Kais Atallah, Sheffield (GB)

(73) Assignee: MAGNOMATICS LIMITED

(21) Appl. No.: 12/989,506

(22) PCT Filed: Apr. 22, 2009
(86) PCT No.: PCT/GB2009/001023

§ 371 Date: Feb. 7, 2011

(30) Foreign Application Priority Data
Apr. 23, 2008 (GB) 0807388.4

(51) Int. Cl. H02K 16/02

(52) U.S. Cl. 310/114

(57) ABSTRACT

Embodiments of the present invention provide an electrical machine comprising a first moveable element having a first plurality of permanent magnets associated therewith, a winding arranged generally adjacent to the first moveable element, wherein the winding is arranged to interact magnetically with a magnetic field of the permanent magnets associated with the first moveable element; a second plurality of permanent magnets; a second moveable element arranged adjacent to the first moveable element and having a plurality of a plurality of pole-pieces associated therewith, wherein the pole pieces are arranged to modulate the fields of the first and second pluralities of permanent magnets to enable magnetic coupling there-between, such that the first and second moveable elements move in a magnetically geared manner.

### FIELD OF THE INVENTION

The present invention relates to electrical machines.

### BACKGROUND TO THE INVENTION

Mechanical gearboxes are extensively used to match the operating speed of prime-movers to the requirements of their loads for both increasing the rotational speed such as, for example, in a wind-powered generators or reducing rotational speed such as, for example, in an electric-ship propulsion arrangement. It is usually more cost and weight effective to employ a high-speed electrical machine in conjunction with a mechanical gearbox to achieve requisite speed and torque characteristics. However, while such a high-speed electrical machine in conjunction with a mechanical gearbox allows high system torque densities to be realised, such mechanical gearboxes usually require lubrication and cooling. Furthermore, reliability can also be a significant issue. Consequently, direct drive electrical machines are employed in applications where a mechanical gearbox cannot be used. Some direct drive electrical machines, such as permanent magnet rotary/linear transverse-flux machines (TFM) have poor power factors which make them unsuitable for electrical power generation and require higher converter volt-ampere ratings for motor applications.

Recently, pseudo-direct drive electrical machines have been proposed by the present inventors in which first and second moveable elements, such as inner and outer rotors, interact in a magnetically geared manner via asynchronous harmonics of first and second pluralities of permanent magnets. Such an assembly is described in various embodiments in GB 2 437 568 by the present inventors which is incorporated herein by reference.

It is an object of embodiments of the present invention to provide improvements to such pseudo-direct drive electrical machines.

### SUMMARY OF INVENTION

An aspect of embodiments of the present invention provides an electric machine, comprising a first moveable element having a first plurality of permanent magnets associated therewith, a winding arranged generally adjacent to the first moveable element, wherein the winding is arranged to interact magnetically with a magnetic field of the permanent magnets associated with the first moveable element; a second plurality of permanent magnets; a second moveable element arranged adjacent to the first moveable element and having a plurality of a plurality of pole-pieces associated therewith, wherein the pole pieces are arranged to modulate the fields of the first and second pluralities of permanent magnets to enable magnetic coupling there-between, such that the first and second moveable elements move in a magnetically geared manner.

Preferably, the first moveable element is arranged to move at a greater-speed than the second moveable element. The first moveable element may be driven by the magnetic influence of the winding.

The first moveable element is preferably a rotor. First and second pluralities of permanent magnets are preferably disposed on interior and exterior surfaces of the rotor. The polarities of the permanent magnets are preferably aligned. However, the two pluralities of permanent magnets may not be aligned and may comprise different number of pole-pairs. A plurality of magnets arranged on an exterior surface of the rotor may comprise a greater number of pole pairs than a plurality of magnets interior to the rotor. In this case, the magnetic field of the permanent magnets interior to the rotor may cause movement of the second moveable element. The pluralities of permanent magnets carried by the rotor may be separated by an annulus. Preferably the moveable element comprises ferromagnetic material. Preferably, the ferromagnetic material is steel, e.g. laminated silicon iron, solid steel or silicon iron or a soft magnetic composite (pressed iron powder). The ferromagnetic material may form a structure of the first moveable element.

The first moveable element may have a cup or bowl-like structure. An annular rim-portion of the structure may support the first and second pluralities of permanent magnets. The first moveable element may be supported perpendicularly to the rim. The first moveable element may be supported at one or both ends. Preferably the moveable element is supported upon one or more bearings. The annular portion of the moveable element may be formed of a different material to a support portion. The support portion may be non-magnetic. First and/or second pluralities of permanent magnets may be mounted upon a ferromagnetic member in the case that the first moveable element is non-magnetic. The first moveable element may or may not be connected to an output shaft. In the case that the first moveable element is not connected to an output shaft, construction of the machine is simplified. The second moveable element is preferably connected to an output shaft.

A plurality of permanent magnets may be formed from one of an isotropic material, an array of anisotropic magnet segments, or pre-aligned anisotropic material. The material may be NdFeB (neodymium, iron, and boron), SmCo (Samarium Cobalt) or Hard Ferrite (Strontium or Barium Ferrites). The material may be epoxy bonded onto the first moveable element or may form the moveable element.

The second moveable element may form an output or input (motor or generator) of the electric machine. The second moveable element is preferably associated with a plurality of pole-pieces. Preferably, the machine further comprises a first stator associated with the second plurality of permanent magnets. The pole pieces preferably couple the magnetic fields of the plurality of permanent magnets associated with the first stator with those of the first moveable element. The machine may further comprise a second stator associated with the winding. Preferably, the first stator is arranged concentrically within the second moveable element. Preferably, the second stator is arranged around the first moveable element. Preferably, the winding is arranged about the second stator adjacent to the first moveable element. That is, the winding and first moveable elements are preferably not interposed by another member or element. The machine may preferably comprise 3 airgaps between moveable elements or moveable and static elements. Preferably, the first and second moveable elements are adjacent. That is, preferably not interposed by a static element or stator.

An aspect of embodiments of the present invention provides an electric machine, comprising a first moveable element having a ferromagnetic member mounted thereon and a plurality of permanent magnets supported upon the ferromagnetic member, wherein the first moveable element is arranged to interact in a magnetically geared manner via the plurality of permanent magnets, with a second moveable element; and a winding arranged to interact magnetically with a magnetic field of the plurality of permanent magnets associated with the first moveable element.

An aspect of embodiments of the present invention provides an electric machine, comprising: a first moveable element having a plurality of permanent magnets forming a Halbach array associated therewith, wherein the first moveable element is arranged to interact in a magnetically geared manner via the plurality of permanent magnets, with a second moveable element; a winding arranged to interact magnetically with a magnetic field of the plurality of permanent magnets associated with the first moveable element.

An aspect of embodiments of the present invention provides an electric machine, comprising: a first moveable element having first and second pluralities of permanent magnets associated therewith, wherein the first moveable element is arranged to interact in a magnetically geared manner, via the first plurality of permanent magnets, with a second moveable element, wherein the first and second pluralities have different numbers of magnetic poles; and a winding arranged to interact magnetically with a magnetic field of the second plurality of permanent magnets associated with the first moveable element.

An aspect of the present invention provides an electric machine, comprising: a first moveable element having a plurality of permanent magnets formed in a magnetised isotropic or anisotropic material associated therewith, wherein the first moveable element is arranged to interact in a magnetically geared manner via the plurality of permanent magnets, with a second moveable element; a winding arranged to interact magnetically with a magnetic field of the plurality of permanent magnets associated with the first moveable element.

### BRIEF DESCRIPTION OF THE DRAWINGS

Embodiments of the present invention will now be described, by way of example only, with reference to the accompanying drawings in which:

FIG. 1 shows an electric machine according to a first preferred embodiment of the present invention;

FIG. 2 shows an electric machine according to a second preferred embodiment of the present invention;

FIG. 3 shows a segment of a rotor according to a preferred embodiment of the present invention;

FIG. 4 shows a rotor according to the preferred embodiment of the present invention;

FIG. 5 shows a rotor according to another preferred embodiment of the present invention;

FIG. 6 shows rotors according to two further preferred embodiments of the present invention;

FIG. 7 shows two rotors according to still further preferred embodiments of the present invention;

FIG. 8 shows preferred embodiments of rotor;

FIG. 9 shows another preferred embodiment of rotor;

FIG. 10 shows an axial field electric machine according to a preferred embodiment of the present invention;

FIG. 11 shows a preferred embodiment of a rotor used in the axial field electric machine;

FIG. 12 shows a further preferred embodiment of an axial field electric machine;

FIG. 13 shows a further preferred embodiment of axial field electric machine;

FIG. 14 shows a preferred embodiment of a linear electric machine;

FIG. 15 shows a preferred embodiment of linear electric machine having a tubular construction; and

FIG. 16 shows a further preferred embodiment of linear electric machine having a tubular construction.

### Description of the preferred embodiments

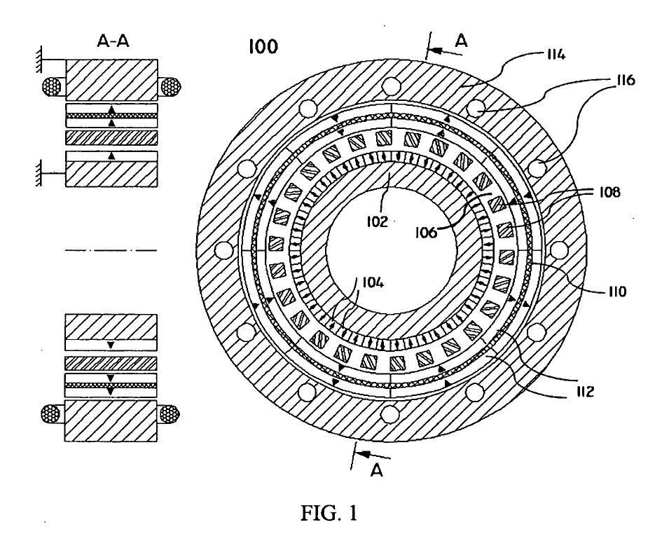

FIG. 1 shows a first preferred embodiment of an electrical machine according to the present invention.

The first embodiment 100 comprises an inner stator 102 having a plurality of permanent magnets 104 mounted around, or carried upon, an outer periphery thereof. In the shown embodiment, 44 permanent magnets forming 22 pole-pairs are carried upon the inner stator 102. However, it will be realised that other numbers of permanent magnets and pole-pairs may be utilised.

Arranged radially around the inner stator 102 is a first, or inner, rotor 106 which carries a plurality of pole-pieces 108. The pole pieces 108 are mounted on or within a substrate 106. Alternatively, the pole pieces 108 may substantially form the rotor 106, for example, by mounting on end plates or end-rings to form a cage-like supporting structure. In the shown example, there are 26 pole pieces 108. However, it will be realised that embodiments of the invention are not limited to such number. A second, or outer, rotor 110 is arranged radially around the outside of the inner rotor 106. As will be explained, the second rotor 110 carries a plurality of permanent magnets 112 thereon. A second, or outer, stator 114 is disposed around the outer rotor 110 and forms an exterior wall of the machine 100. The second stator 114 has a three-phase winding 116 running there-through, although it will be realised that a winding 116 carrying another number of phases, such as two or five phases, can be utilised.

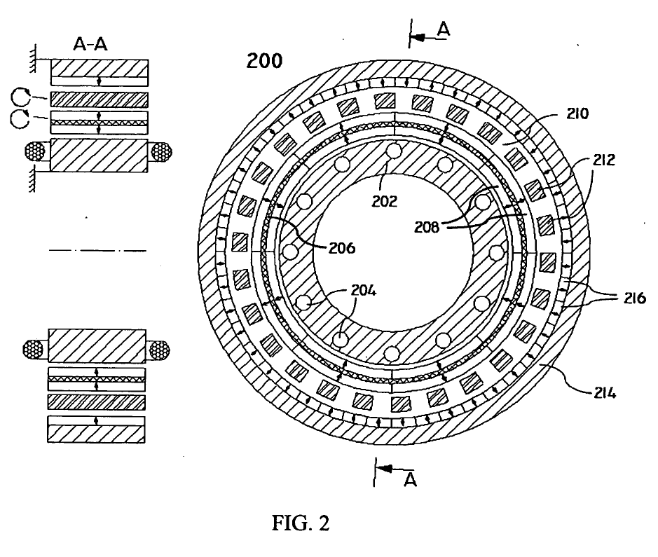

FIG. 2 shows a second preferred embodiment of an electrical machine according to the present invention.

The second embodiment 200 comprises a first, inner, stator 202 through which a multiple-phase, for example, three-phase, winding 204 is arranged. Disposed around the inner stator 202 is a first, inner, rotor 206 which, as will be explained, carries a plurality of permanent magnets 208. A second, outer, rotor 210, disposed around the inner rotor 206, carries a plurality of pole-pieces 212. A second, outer, stator 214 is disposed around a periphery of the apparatus and carries, on an inner circumference or periphery thereof, a plurality of permanent magnets 216 forming a plurality of pole-pairs. In the preferred embodiment, there are 22 pole-pairs formed by 44 permanent magnets 216. However, other numbers of permanent magnets 216 may be utilised.

A brief description of the operation of the first and second embodiments 100, 200 of electrical machines will now be provided.

The 3-phase windings 116, 204, and associated currents, are arranged to create magnetic fields that couple with the first or fundamental harmonic of the magnetic field produced by the permanent magnets 112, 208 associated with the rotor 110, 206 carrying a plurality of permanent magnets 112, 208, in order to produce torque and the fundamental harmonic of the permanent magnet 112, 208 array couples with the winding 116, 202 to produce an electromotive force (EMF). That is, in the first embodiment 100, the magnetic field produced by the winding 116 couples with a magnetic field of the permanent magnets 112 carried upon the second rotor 110. In the first embodiment illustrated, the first/fundamental harmonic corresponding to the permanent magnets 112 has 4 pole-pairs. In the second embodiment, the magnetic field produced by the winding 204 couples with a magnetic field of the permanent magnets 208 carried upon the first rotor 206.

The following describes the operation of the machine as a motor. The rotors 110 and 206 carrying the permanent magnets 112, 208 are caused to rotate at a relatively high-speed by the current flow in the windings 116, 204. In order to cause geared rotation of the other rotor in each embodiment 106, 210 a coupling between the pluralities of fixed and rotatable permanent magnets 112, 104 and 208, 216 respectively is realised using the rotatable pole pieces 108, 212. The pole pieces 108, 212 are used to allow the fields of the permanent magnets 112, 104 and 208, 216 to interact. The pole pieces 108, 212 modulate the magnetic fields of the permanent magnets 112, 104 and 208, 216 so they interact to the extent that rotation of one rotor 110, 206, caused by the current flow in the windings, will induce rotation of the other rotor 106, 210 in a geared manner. Rotation of the first rotor 110, 206 at a speed ω₁ will induce rotation of the second rotor 106, 210 at a speed ω₂ where ω₁>ω₂ and visa versa. Consequently, the low-torque drive applied to the high-speed rotor 110, 206 is converted to a high-torque drive output by the low-speed rotor 106, 210. This gearing allows the production of an electrical machine capable of producing a high-torque to be made consequently smaller. In more detail, the pole pieces 106 modulate the magnetic field of the permanent magnets 112, 208. For the permanent magnets 112, 208, for example, this results in a relatively large asynchronous harmonic having the same number of poles as the permanent magnets 104, 216, which enables coupling between the first 110, 206 and the second 106, 210 rotors such that movement of one induces movement of the other, in a geared manner. Alternatively, when acting as a generator, a low speed high torque mechanical drive (e.g. wind turbine) is connected to the pole piece rotor (108,212). The action of the magnetic gearing causes the rotatable permanent magnets (110,206) to rotate at a higher speeds.

One skilled in the art understands how to select and design the pole pieces 108, 212, given the first 112, 208 and second 104, 216 pluralities of permanent magnets, to achieve the necessary magnetic circuit or coupling such that gearing between the first 110, 206 and second 106, 210 rotors results as can be appreciated from, for example, K. Atallah, D. Howe, “A novel high-performance magnetic gear”, IEEE Transactions on Magnetics, Vol. 37, No. 4, pp. 2844-2846, 2001 and K. Atallah, S. D. Calverley, D. Howe, “Design, analysis and realisation of a high performance magnetic gear”, IEE Proceedings—Electric Power Applications, Vol. 151, pp. 135-143, 2004, which are incorporated herein by reference for all purposes.

Advantageously, in embodiments of the present invention, efficiency of the electric machine is improved due to the location of a winding 116, 202 being generally adjacent to a high-speed moveable element which it drives 110, 206. Still further, the high-pole number permanent magnet array 104, 216 is mounted upon a stator 102, 214 which provides a more convenient mounting arrangement for this plurality of permanent magnets and avoids a need to contain the permanent magnets against centrifugal loads.

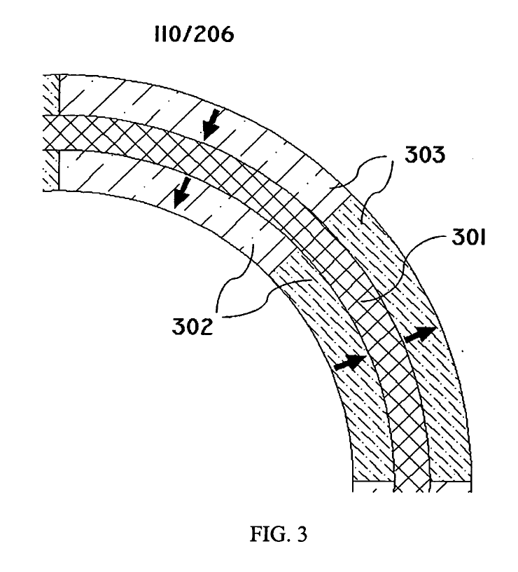

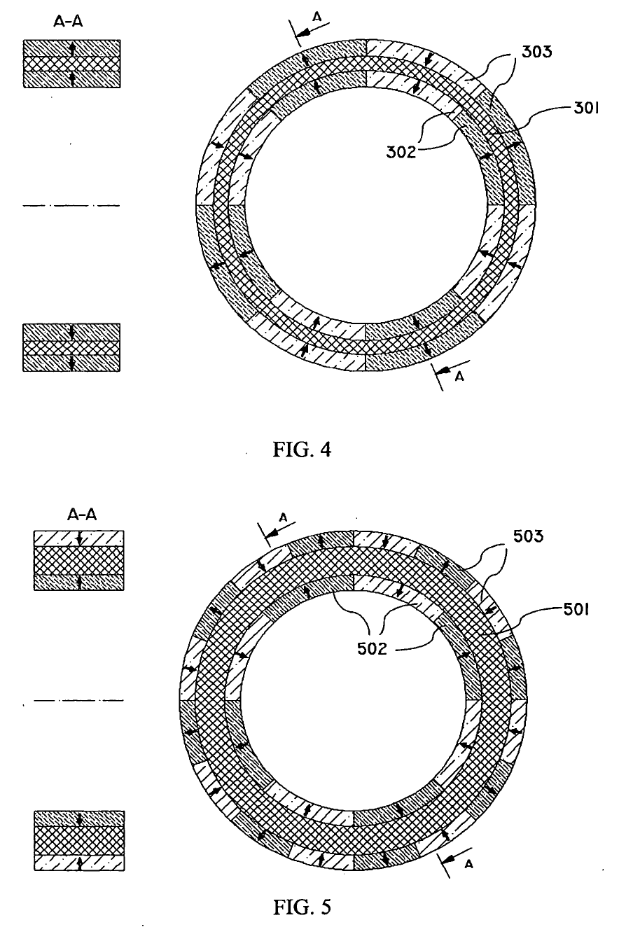

Referring to FIGS. 3 and 4, a portion of, and an entire, first preferred embodiment of a rotor 110, 206 utilised in the first and second preferred embodiments 110, 200 of electrical machine are respectively shown.

The rotor 110, 206 is formed by an annular ferromagnetic member 301. The ferromagnetic material is, in the preferred embodiment, steel, e.g. laminated silicon iron, solid steel or silicon iron or a soft magnetic composite (pressed iron powder). Opposing faces of the member 301 have mounted thereon first and second pluralities of permanent magnets in an array. A first plurality of permanent magnets 302 is mounted upon an interior surface of the ferromagnetic member 301 and a second plurality of permanent magnets 303 is mounted upon an exterior surface of the ferromagnetic member 301. In the preferred embodiment, the first and second pluralities of permanent magnets 302, 303 have identical pole numbers and the extents of each pole in the respective magnet arrays are aligned. In the first embodiment of rotor 110, 206, there are 8 permanent magnets forming the respective arrays of permanent magnets, producing a 4 pole-pair magnetic field. However, other numbers of permanent magnets and pole-pairs may be utilised.

The ferromagnetic member 110, 206 conducts magnetic flux from the inner magnet array 302 to the outer magnet array 303 and vice versa, without creating any detrimental electromagnetic effects. Further, the design is not sensitive to the thickness of the ferromagnetic member 110, 206 and, hence, the ferromagnetic member 110, 206 may be of sufficient thickness to have a required physical strength for the annular rotor 110, 206. The use of steel, in the preferred embodiment, does not contribute to the overall magnetic airgap and open surfaces of the magnets are conducive to a high level of heat rejection to prevent the permanent magnets 302, 303 from overheating. Advantageously, the rotor 110, 206 has good mechanical strength, is cheap to produce and has a simple construction.

FIG. 5 shows a second preferred embodiment of a rotor 110, 206 for use in an electrical machine. Essentially, the second preferred embodiment of rotor has two permanent magnet arrays on opposing surfaces of a ferromagnetic member which differ in pole-number.

The second embodiment of rotor 110, 206 comprises an annular ferromagnetic member 501 having a first plurality of permanent magnets 502 in the form of an array attached to an interior surface thereof. A second plurality of permanent magnets 503 is mounted in the form of an array upon an opposing exterior surface thereof. In the second preferred embodiment, the numbers of permanent magnets forming the first and second pluralities 502, 503 are not equal. Consequently, the extent of each pole in the first and second pluralities 502, 500 does not correspond. That is, poles in each plurality do not have corresponding end-points. In the shown embodiment, the interior plurality 502 comprises 8 permanent magnets forming 4 pole-pairs, whilst the exterior array comprises 16 permanent magnets forming 8 pole-pairs. There is a 2:1 correspondence between the numbers of permanent magnets between the exterior 503 and interior pluralities of permanent magnets. It will be realised that other numbers of permanent magnets and pole-pairs may be utilised however.

The use of differing pole-number permanent magnet arrays allows a different number of poles to be used on the machine i.e. winding coupling and gear i.e. pole-piece coupling elements of the machine. This allows the design of the machine and gearing magnetics to be decoupled. For example, a high pole-number machine may be required to achieve a certain frequency when the machine is acting as a generator, or to minimise back iron size, whilst a low gearing pole-number may be required to achieve a predetermined gear ratio without requiring a very high number of stationary magnets.

The use of a ferromagnetic member interposing first and second pluralities of permanent magnets 302, 303, 502, 503 has further advantages in terms of electrical machine design. In particular, simplified mounting of the rotor upon bearing supports is achieved.

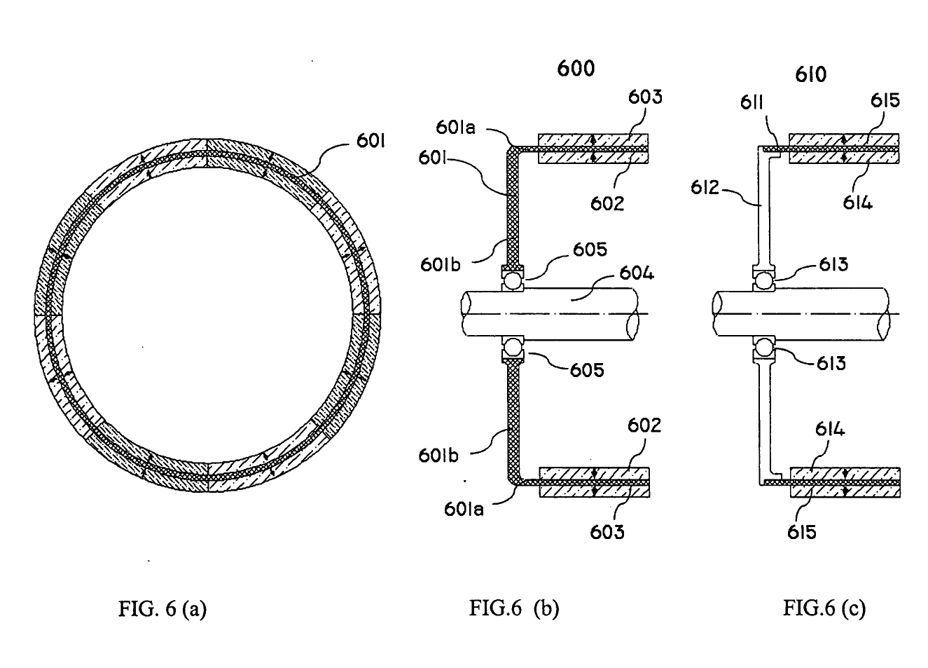

FIG. 6 shows two further preferred embodiments of rotor construction and mounting structure. The two embodiments shown in FIG. 6 are mounted having single-ended support from bearings.

FIG. 6(a) shows a rotor 600 as in the first preferred embodiment shown in FIG. 3.

The rotor is shown in FIG. 6(a) in plan view and in FIG. 6(b) in side cross-section through a central axis thereof. The rotor 600 comprises a ferromagnetic member 601 having an annular portion upon which first 602 and second 603 arrays of permanent magnets are mounted upon interior and exterior surfaces respectively. Extending inwardly from an end of annular portion 601a is a support portion 601b. The support portion 601b is arranged perpendicular to the walls of the annular portion to provide support thereto from a shaft 604 upon which the rotor 600 is rotatable mounted by bearings 605. The support portion 601b extends radially outward from the shaft 604 toward the annular portion 601a and may be in the form of arms, spokes, disc or an alternative supporting construction. The annular 601a and support 601b portions form a cup or bowl-shape when viewed in side-cross section. This construction simplifies manufacture of the rotor 600, assembly and disassembly thereof, for example, during construction or maintenance.

In the first embodiment, the rotor is constructed from a single unitary piece of ferromagnetic material, such as steel, which reduces a manufacturing cost.

Referring to FIG. 6(c) there is shown a further preferred embodiment of rotor 610. The rotor 610 has the same cup or bowl-shape as the first embodiment, but is manufactured and constructed from two pieces of different material.

The rotor 610 is comprised of an annular ferromagnetic part 611 and a support part 612. The support part extends from shaft-mounted bearings 613 and supports the annular part 611 at a first, single, end thereof. The annular part carries first 614 and second 615 pluralities of permanent magnets on interior and exterior surfaces thereof. The annular and support parts 611, 612 are formed of different materials. For example, the ferromagnetic annular part 611 may be supported upon a non-magnetic support part 612, such as made from a composite material. This allows different materials to be used to improve magnetic properties of the rotor 610. This construction also allows the ferromagnetic part 611 to be formed of a laminar construction and/or the support part to be solid, which would increase strength.

In the embodiments of rotor 600, 610 shown in FIGS. 6(a)-(c) single-ended support has been shown. However, it will be realised that double-ended support from bearings arranged at either end of the rotor may be provided.

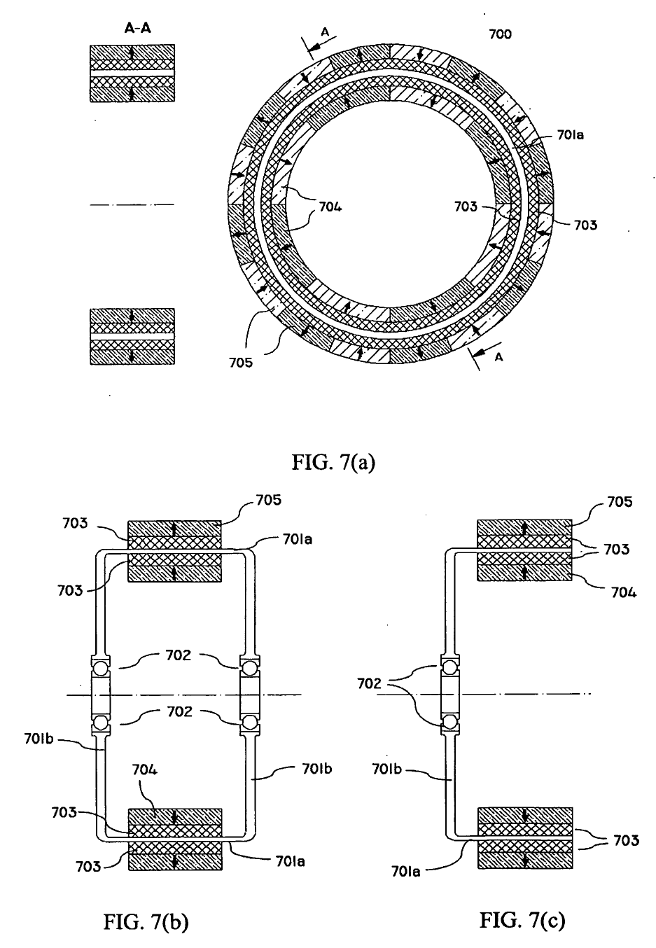

A construction of rotor 700 having a multi-layer or laminar construction will now be described with reference to FIG. 7. This embodiment of rotor is useful when permanent magnets are desired to be mounted upon back irons which are laminated, have poor mechanical strength, or when the rotor is operated at high-speed.

As shown in FIG. 7, the rotor 700 comprises a support 701 having an annular part 701a upon which pluralities of permanent magnets are mounted, as will be explained, and a support part 701b which supports the annular part 701a upon bearings 702 to be rotatable. As shown in FIGS. 7(b) and (c) the support part may be single or double-ended. That is, the annular part 701a may be supported upon bearings at one or both ends thereof. The support 701 is manufactured from a material having a high-degree of mechanical strength and may be ferromagnetic, such as steel, or non-magnetic, such as a composite material.

Mounted upon interior and exterior surfaces of the annular part 701a are ferromagnetic back irons 703. An array of permanent magnets 704, 705 is mounted upon each of the back irons. This embodiment allows a laminar back iron to be utilised having poor mechanical strength or a support 701 having a light weight, such as a composite material. Whilst shown having both permanent magnet arrays mounted upon back irons, an embodiment can be conceived in which the support part is ferromagnetic and only a single back iron is provided for one of the permanent magnet arrays. Different numbers of poles may be provided in the interior and exterior magnet arrays.

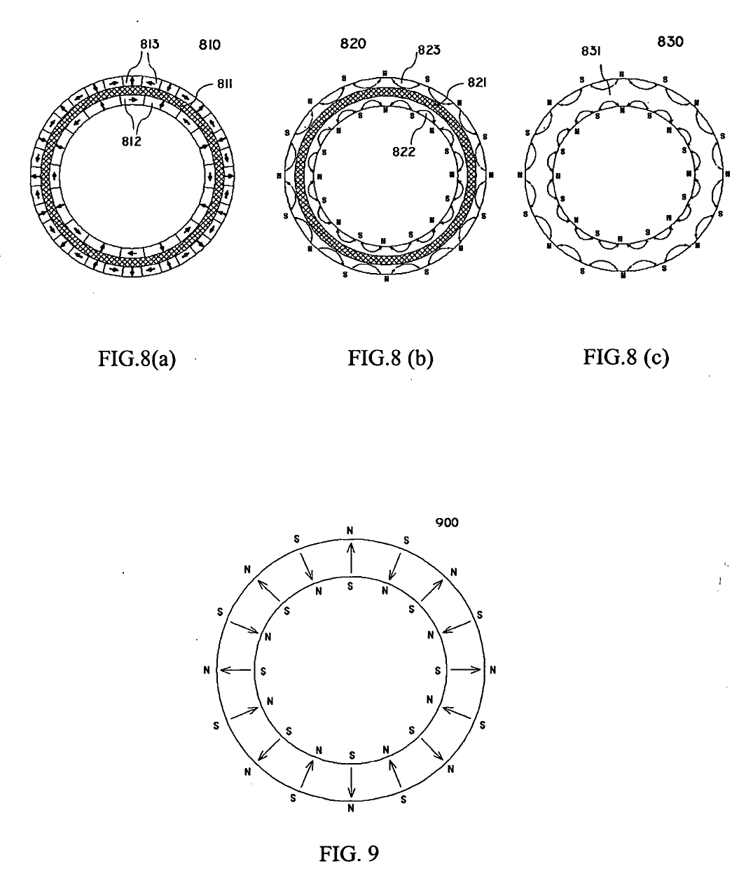

FIG. 8 shows three preferred embodiments of rotors for use with electrical machines. The rotors shown in FIG. 8 do not require a back iron and thus may be made from non-magnetic material having high-strength e.g. for use in a large electrical machine, light-weight or a combination thereof. Examples of such materials are titanium, an Inconel (™) alloy (high-strength) or a composite material (light-weight) such as carbon-fibre composite.

FIG. 8(a) shows a rotor 810 in plan-view comprising an annular part 811 having first 812 and second 813 arrays of permanent magnets mounted upon interior and exterior opposing surfaces thereof.

The arrays of permanent magnets 812, 813 are configured as a Halbach array. A Halbach array is an arrangement of permanent magnets in which a magnetic field to one side of the array is enhanced whilst a magnetic field on an opposing side is cancelled. That is, the array is self-shielding, wherein a flux return path is within the permanent magnet material itself. A back iron is not then required and the rotor 810 may be manufactured from a non-magnetic material, or a material having a lower ferromagnetic material content or thickness, particularly in the case that the Halbach array is imperfect or an approximation to a Halbach array and not fully self-shielding.

The embodiment shown in FIG. 8(a) comprises discrete permanent magnets arranged to form a Halbach array on each side of the annular part 811 of the rotor 810. The first and second arrays 812, 813 may have different pole-numbers as in the shown embodiment.

Referring to FIG. 8(b) a rotor 820 is shown in which Halbach arrays of permanent magnets are formed in an isotropic material. The rotor 820 comprises an annular part 821 having first 822 and second 823 magnetic rings mounted upon interior and exterior opposing surfaces thereof. Such rings may be made from epoxy bonded NdFeB. A single-shot magnetising fixture, or similar, is utilised to imprint a Halbach self-shielding magnetisation pattern upon the magnetic rings 822, 823. The magnetic rings 822, 823 may be manufactured as a unitary part, simplifying construction, or as a plurality of parts or pieces. The magnetic rings 822, 823 may be over-moulded on a support ring and then magnetised as a single component. As will be realised, over-moulding is a process by which the magnetic rings would be moulded about a supporting ring or part.

In a further embodiment 830, shown in FIG. 8(c), a Halbach array of permanent magnets is provided without a supporting structure. That is, a rotor is formed of an isotropic material 831 without a support structure i.e. self-supporting. A single-shot impulse magnetising fixture, or similar, is utilised to imprint a pair of Halbach magnetisation patterns upon the magnetic ring to form first and second Halbach arrays. This is particularly useful in machines desired to have light-weight rotors which are high in strength having low inertia. Such a ring may be made from a magnetically-loaded carbon fibre composite tube. The same technique may be used, as shown in FIG. 9, to produce a rotor 900 having through-magnetisation, that is, conventionally directed pole-pairs. This avoids the need to construct a rotor 900 using discrete permanent magnets. The ring may be made from a radially anisotropic, isotropic material or a reinforced material such as magnetically-loaded carbon fibre composite tube.

The use of moveable members having arrays of permanent magnets carried upon opposing faces in electrical machines is not limited to radial field machines.

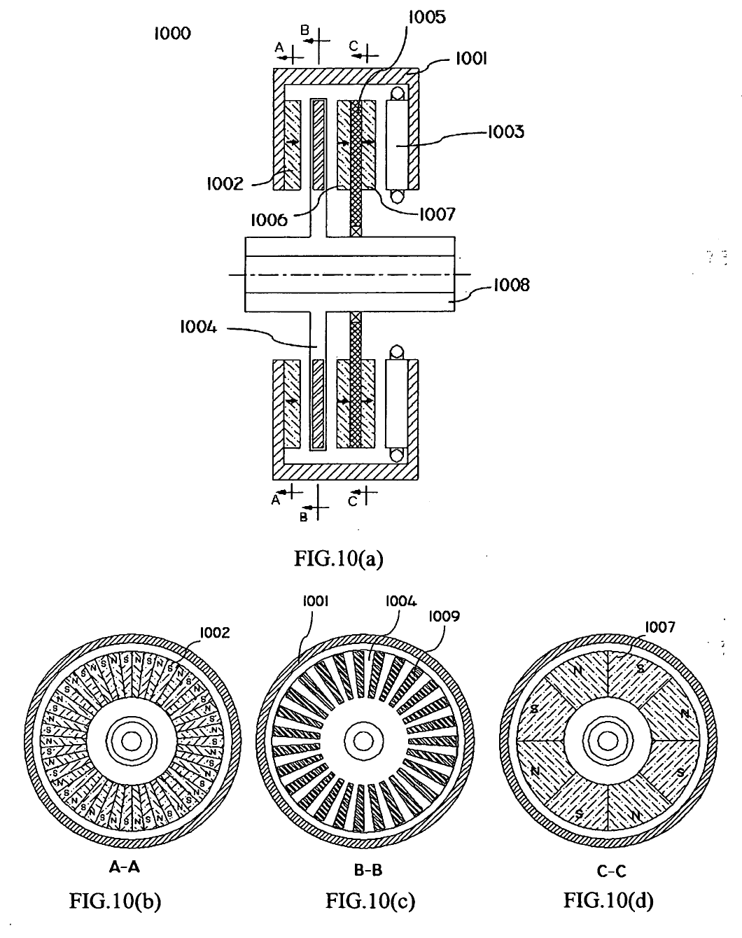

FIG. 10(a) shows an axial field electric machine 1000 comprising a stator case 1001 having a static, inwardly-facing, high-pole number array of permanent magnets 1002 mounted upon an interior surface, an armature/stator incorporating a multiphase winding 1003 mounted upon an opposing interior face of the stator case 1001, a low-speed, high-torque, rotor 1004 carrying a plurality of pole pieces 1009, a high-speed rotor 1005 carrying first 1006 and second 1007 arrays of permanent magnets upon opposed surfaces thereof, and an input/output shaft 1008. It can be seen that the stator case features an inwardly directed arm at either end thereof which are interposed by the rotors 1004, 1005. FIG. 10(b) shows a cross-section through the machine at A-A shown in FIG. 10(a). The arrangement of the high-pole number array of permanent magnets 1002 mounted upon the interior-facing surface of the stator case 1001 may be appreciated. FIG. 10(c) shows a cross section at line B-B through the rotor 1004 carrying the pole pieces 1009, whilst FIG. 10(d) shows a cross section along line C-C in FIG. 10(a) which shows the second array 1007 of permanent magnets mounted upon the high-speed rotor 1005.

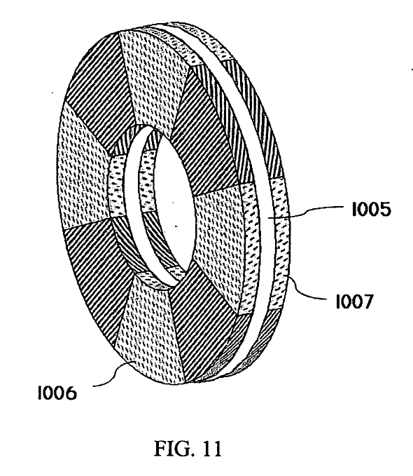

FIG. 11 shows the rotor 1005 of FIG. 10 in more detail. The rotor 1005 is made from a disc-like ferromagnetic material, such as steel, having a central aperture for mounting upon a shaft. The rotor 1005 is hence annular. A first plurality of permanent magnets 1006 is mounted on a first face of the rotor 1005 and a second plurality of permanent magnets 1007 is mounted upon a second face opposed to the first face. In the shown embodiment, the opposing faces carry 8 pole pairs with equal pole-pair of permanent magnets on each face. However, unequal numbers of pole-pairs could be carried upon the faces.

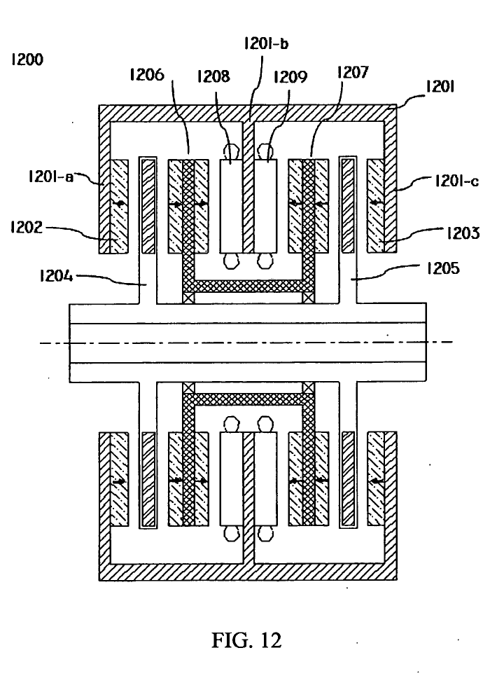

FIG. 12 shows a second preferred embodiment of axial field electric machine 1200 which reduces a normal force experienced on the pole-pieces or magnets by using a dual armature configuration.

The electric machine 1200 comprises a stator case 1201 having first and second static, inwardly-facing, high-pole number arrays of permanent magnets 1202, 1203 mounted upon interior surfaces of the stator case 1201 at either end of the machine. Proximal to the permanent magnet arrays 1202, 1203 at either end of the machine are a pair of low-speed, high-torque, rotors 1204, 1205 carrying a plurality of pole-pieces. Adjacent thereto, there is arranged a pair of high-speed rotors 1206, 1207, each carrying first and second pluralities of permanent magnets on opposing faces, as shown in FIG. 11. Centrally within the machine are provided stator armatures incorporating multiphase windings 1208, 1209 and an input/output shaft 1210. It can be seen that the stator case 1201 features inwardly extending arms 1201a-c at either end and in a centre thereof. Each pair of arms 1201a,b and 1201b,c is interposed by input and output rotors.

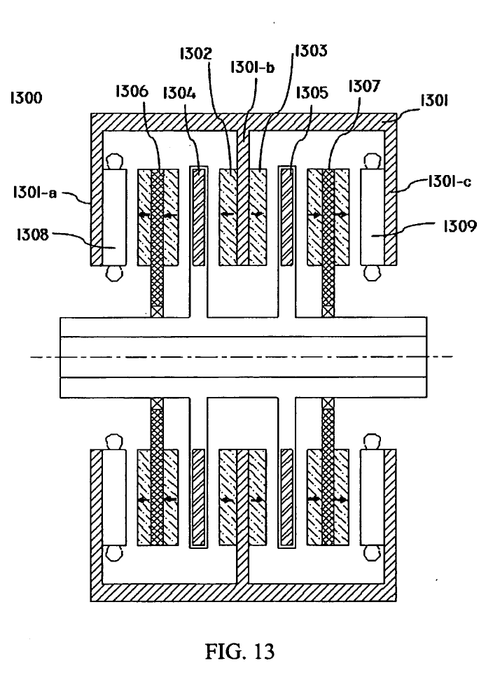

FIG. 13 shows a further embodiment of axial field electric machine. 1300 in which stator armatures are arranged at opposing, outer, ends of the machine.

The electric machine 1300 comprises a stator case 1301 featuring inwardly extending arms 1201a,c at either end and in a centre thereof 1301b. Mounted upon an interior, inwardly facing, surface of the arms 1301a, c are stator armatures incorporating multiphase windings 1208, 1209. Adjacent thereto, there is arranged a pair of high-speed rotors 1306, 1307, each carrying first and second pluralities of permanent magnets on opposing faces. Interposing permanent magnet arrays 1302, 1303 arranged upon opposing sides of arm 1301b are a pair of low-speed, high-torque, rotors 1304, 1305 carrying a plurality of pole-pieces.

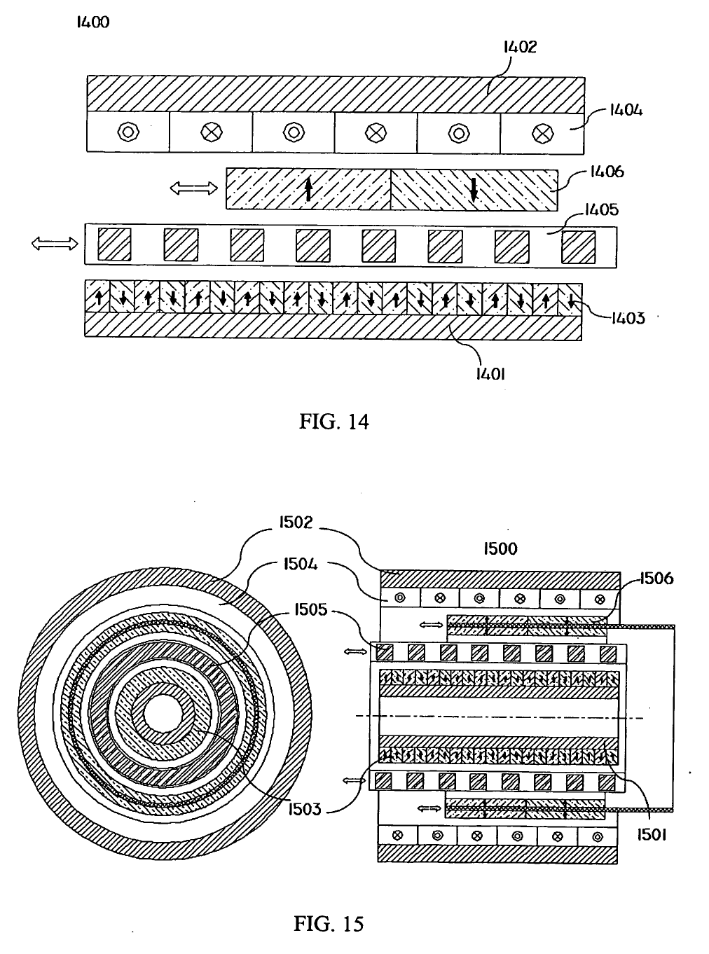

A linear electric machine featuring a pair of stators is shown in FIG. 14. The machine 1400 comprises first and second stators 1401, 1402 forming exterior walls at either side of the machine. Attached to an interior facing surface of the first stator 1401 is a plurality of permanent magnets forming a first permanent magnet array 1403. Similarly, attached to an interior side of the opposing stator 1402 is a winding 1404. Interposing the stators 1401, 1402, magnet array 1403 and windings 1404 is a low speed, high-torque, pole-piece armature 1405 which is moveable in first and second opposed linear directions. A high-speed armature 1406 carrying a plurality of permanent magnets is similarly moveable in first and second opposed linear directions. It can be seen that the winding 14304 is adjacent to the moveable element carrying a first plurality of permanent magnets, with which it magnetically interacts to cause movement of that moveable element 1405. The plurality of permanent magnets carried by the high-speed moveable element 1405 is coupled via the plurality of pole pieces to the second plurality of permanent magnets 1403, such that movement of the high-speed armature 1406 causes geared movement of the low-speed armature 1405. The magnet array 1406 may be formed as a pair of magnet arrays having different pole numbers mounted upon opposing faces of the moveable element.

Whilst the electric machine shown in FIG. 14 is planar, FIG. 15 shows a tubular construction of a similar electric machine 1500 in cross-sections aligned with and perpendicular to an axis of the machine.

The machine 1500 comprises a first tubular stator 1501 arranged at a centre of the machine and a second stator 1502 arranged to form an outer periphery or case of the machine. Arranged around an exterior surface of the first stator 1501 is a plurality of permanent magnets forming a first magnet array 1503 having a high-pole number. Adjacent to the first magnet array 1503 is pole-piece armature 1505 which encircles the first stator 1501 and magnet array 1503. The pole-piece armature 1505 is forms a low-speed armature and is moveable in first and second linearly opposed directions, as shown. Arranged around the pole-piece armature 1505 is a high-speed armature 1506 carrying one or two arrays of permanent magnets as in the embodiment described with reference to FIG. 14. A winding 1504 is carried upon an interior surface of the stator case 1502. Operation of the electric machine is as described with reference to FIG. 14.

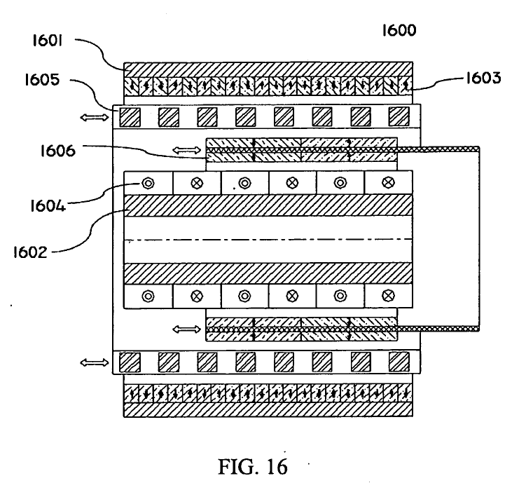

A further embodiment of electric machine 1600 is shown in FIG. 16. The electric machine 1600 has a similar tubular arrangement to that shown in FIG. 15.

However, a tubular stator 1602 is arranged centrally to the machine 1600 carrying a winding 1604 upon an exterior, outwardly facing, surface thereof. Around the stator 1602 and winding 1604 is a linearly moveable element 1606 having one or two arrays of permanent magnets carried thereon. Around the moveable element 1606 is a further moveable element 1605 having a plurality of pole-pieces associated therewith. An exterior or case of the electric machine 1600 is formed by a further stator 1601 having a high pole-number array of permanent magnets 1603 arranged upon an interior surface thereof. Operation of the electric machine 1600 is as described with reference to FIGS. 14 and 15.

It will be appreciated that embodiments of the invention have been described with reference to electrical machines. One skilled in the art appreciates that such electrical machines can be used as motors or generators. When so-used, applying a 3-phase supply to the windings results in a geared electrical motor. However, rotating one of the rotors results in the electrical machine being used as a geared generator. Furthermore, although the above embodiments have been described with reference to using a 3-phase winding, embodiments are not limited to such an arrangement. Embodiments can be realised in which some other form of winding such as, for example, a 2-phase windings, is used.

1. An electric machine, comprising:
a first moveable element having a first plurality of permanent magnets associated therewith,
a winding arranged generally adjacent to the first moveable element, wherein the winding is arranged to interact magnetically with a magnetic field of the permanent magnets associated with the first moveable element;
a second plurality of permanent magnets;
a second moveable element arranged adjacent to the first moveable element and having a plurality of a plurality of pole-pieces associated therewith, wherein the pole pieces are arranged to modulate the fields of the first and second pluralities of permanent magnets to enable magnetic coupling there-between, such that the first and second moveable elements move in a magnetically geared manner.

2. The electric machine as claimed in claim 1, comprising a first stator having the winding associated therewith.

3. The electric machine as claimed in claim 1 or 2, wherein the first stator is arranged adjacent to the first moveable element.

4. The electric machine as claimed in claim 1, 2 or 3, wherein the first stator is arranged around the first moveable element.

5. The electric machine as claimed in claim 1, 2 or 3, wherein the first stator is arranged interior to the first moveable element.

6. The electric machine as claimed in any preceding claim, comprising a second stator having the second plurality of permanent magnets associated therewith.

7. The electric machine as claimed in claim 6, wherein the second stator is arranged adjacent to the second moveable element.

8. The electric machine as claimed in claim 6 or 7, wherein the first and second stators are interposed by the first and second moveable elements.

9. The electric machine as claimed in any preceding claim, comprising three air-gaps.

10. The electric machine as claimed in any preceding claim, wherein the plurality of permanent magnets associated with the first moveable element has a first number of pole-pairs and the second plurality of permanent magnets has a second number of pole-pairs which is greater than the first number.

11. The electric machine as claimed in any preceding claim, wherein the winding is arranged to interact with a fundamental harmonic of the magnetic field of the plurality of permanent magnets associated with the first moveable element.

12. The electric machine as claimed in any preceding claim, wherein the first plurality of permanent magnets is arranged upon a first side of the first moveable element and a third plurality of permanent magnets is arranged upon an opposing side of the first moveable element.

13. The electric machine as claimed in claim 12, wherein the first and third pluralities of permanent magnets have equal pole-numbers.

14. The electric machine as claimed in claim 12, wherein the first and third pluralities of permanent magnets have differing pole-numbers.

15. The electric machine as claimed in claim 12, 13 or 14, wherein the first and second moveable elements are rotors and the first and third pluralities of permanent magnets are disposed on interior and exterior surfaces of a first rotor respectively.

16. The electric machine as claimed in any preceding claim, wherein the first and third pluralities of magnets are interposed by a ferromagnetic member.

17. The electric machine as claimed in any of claims 12 to 16, wherein at least one of the first and third pluralities of permanent magnets are mounted upon a ferromagnetic back iron.

18. The electric machine as claimed in claims 12 to 17, wherein the first and third pluralities of magnets are formed in first and second rings of a magnetised isotropic material.

19. The electric machine as claimed in claim 18, wherein the rings are formed of NdFeB.

20. The electric machine as claimed in claims 12 to 17, wherein the first and third pluralities of magnets are formed in first and second rings of a magnetised anisotropic material.

21. The electric machine as claimed in any of claims 12 to 20, wherein at least one of the first and third pluralities of permanent magnets forms a Halbach array.

22. The electric machine as claimed in any of claims 12 to 21, wherein the winding is arranged to interact with a fundamental harmonic of the magnetic field of one of the first and third pluralities of permanent magnets.

23. The electrical machine as claimed in any preceding claim, wherein the first and second moveable elements and first and second stators are cylindrically shaped, and concentrically disposed relative to an axis of rotation thereby forming a radial field rotary electrical machine.

24. The electrical machine as claimed in any of claims 1 to 22, where the first and second moveable elements are at least one of annular or disc shaped, and the first and second stators are axially disposed along the axis of rotation thereby forming an axial field rotary electrical machine.

25. The electrical machine as claimed in any of claims 1 to 22, where the first and second moveable elements are elongate members arranged to move in first and second linearly opposed directions, thereby forming a liner field electric machine.

26. An electric machine, comprising:
a first moveable element having a ferromagnetic member mounted thereon and a plurality of permanent magnets supported upon the ferromagnetic member, wherein the first moveable element is arranged to interact in a magnetically geared manner via the plurality of permanent magnets, with a second moveable element; and
a winding arranged to interact magnetically with a magnetic field of the plurality of permanent magnets associated with the first moveable element.

27. The electric machine as claimed in claim 26, wherein the first moveable element is non-magnetic.

28. The electric machine as claimed in claim 26 or 27, wherein the moveable element comprises an annular portion having the ferromagnetic member mounted thereon.

29. The electric machine as claimed in claim 28, wherein the ferromagnetic member is mounted upon an exterior surface of the annular portion.

30. The electric machine as claimed in claim 28, wherein the ferromagnetic member is mounted upon an interior surface of the annular portion.

31. The electric machine as claimed in any or claims 26 to 30, comprising a second ferromagnetic member having a plurality of permanent magnets supported thereon.

32. The electric machine as claimed in claim 31, wherein the first and second ferromagnetic members are supported upon opposing sides of the moveable element.

33. The electric machine as claimed in any of claims 26 to 32, wherein the first moveable element is rotatably supported at a first end thereof.

34. The electric machine as claimed in any of claims 26 to 32, wherein the first moveable member is rotatably supported at first and second opposing ends thereof.

35. An element for use in an electric machine, comprising a ferromagnetic element having a plurality of permanent magnets mounted thereon.

36. The element as claimed in claim 35, wherein the element is non-magnetic.

37. The element as claimed in claim 35 or 36, wherein the moveable element comprises an annular portion having the ferromagnetic element mounted thereon.

38. The element as claimed in claim 37, comprising a support portion arranged to support the annular portion upon a bearing.

39. The element as claimed in claim 38, wherein the support and annular portions are perpendicularly disposed.

40. The element as claimed in any of claims 35 to 39, comprising a second ferromagnetic member having a plurality of permanent magnets supported thereon.

41. An electric machine, comprising:
a first moveable element having a plurality of permanent magnets forming a Halbach array associated therewith, wherein the first moveable element is arranged to interact in a magnetically geared manner via the plurality of permanent magnets, with a second moveable element;
a winding arranged to interact magnetically with a magnetic field of the plurality of permanent magnets associated with the first moveable element.

42. The electric machine as claimed in claim 41, the first moveable element having a second plurality of permanent magnets forming a Halbach array associated therewith.

43. The electric machine as claimed in claim 42, wherein the first and second Halbach arrays are disposed upon opposing faces of the first moveable element.

44. The electric machine as claimed in claim 42 or 43, wherein the first and second Halbach arrays comprise different pole-numbers.

45. The electric machine as claimed in claim 42, 43 or 44, wherein the first and second Halbach arrays are arranged to form first and second opposed magnetic fields.

46. The electric machine as claimed in any of claims 41 to 45, wherein the Halbach array(s) are formed of discrete permanent magnets.

47. The electric machine as claimed in any of claims 41 to 45, wherein the Halbach array(s) are formed of a magnetised isotropic material.

48. The electric machine as claimed in any of claims 41 to 47, wherein the first moveable member is formed of a magnetised isotropic material and comprises the permanent magnets forming the Halbach array(s).

49. An element for use in an electric machine, comprising a plurality of permanent magnets forming a Halbach array.

50. The element as claimed in claim 49, comprising a second plurality of permanent magnets forming a Halbach array.

51. The element as claimed in claim 50, wherein the first and second pluralities of magnets are disposed on opposing surfaces of the member.

52. The element as claimed in claim 49, 50 or 51, wherein the element is one of a rotor, disc or an elongate member.

53. An electric machine, comprising:
a first moveable element having first and second pluralities of permanent magnets associated therewith, wherein the first moveable element is arranged to interact in a magnetically geared manner, via the first plurality of permanent magnets, with a second moveable element, wherein the first and second pluralities have different numbers of magnetic poles; and
a winding arranged to interact magnetically with a magnetic field of the second plurality of permanent magnets associated with the first moveable element.

54. The electric machine as claimed in claim 53, wherein the first and second pluralities of magnets are disposed on opposing sides of the first moveable element.

55. The electric machine as claimed in claim 53 or 54, wherein the first and second moveable elements are rotors and the first and second pluralities of permanent magnets are disposed on interior and exterior surfaces, respectively, of a first rotor.

56. The electric machine as claimed in claim 53, 54 or 55, wherein the first and second pluralities of magnets are interposed by a ferromagnetic member.

57. The electric machine as claimed in any of claims 53 to 56, wherein the first and second pluralities of magnets are formed in first and second rings of magnetised isotropic material.

58. The electric machine as claimed in any of claims 53 to 57, wherein at least one of the first and second pluralities of permanent magnets forms a Halbach array.

59. The electric machine as claimed in any of claims 53 to 58, wherein the second moveable element has a third plurality of permanent magnets associated therewith.

60. The electric machine as claimed in any of claims 53 to 59, comprising a plurality of pole-pieces arranged to modulate magnetic fields produced by the first and third pluralities of permanent magnets to cause magnetic coupling there-between.

61. An element for use in an electric machine, comprising first and second pluralities of permanent magnets having differing numbers of poles.

62. An electric machine, comprising:
a first moveable element having a plurality of permanent magnets formed in a magnetised isotropic or anisotropic material associated therewith, wherein the first moveable element is arranged to interact in a magnetically geared manner via the plurality of permanent magnets, with a second moveable element;
a winding arranged to interact magnetically with a magnetic field of the plurality of permanent magnets associated with the first moveable element.

63. The electric machine as claimed in claim 58, comprising a second plurality of permanent magnets formed in the magnetised isotropic material.

64. The electric machine as claimed in claim 58 or 59, wherein the isotropic material is supported upon the first moveable element.

65. The electric machine as claimed in claim 58 or 59, wherein the first moveable element comprises the isotropic material.

66. A method of manufacturing an element for use in an electric machine, comprising magnetising one of an isotropic or anisotropic material.

67. The method as claimed in claim 66, comprising magnetising the material to form a first array of permanent magnets.

68. The method as claimed in claim 67, comprising magnetising the material to form a second array of permanent magnets.

69. The method as claimed in any preceding claim 66, 67 or 68, wherein the array of permanent magnets is a Halbach array.

70. An element for use in an electric machine, comprising a plurality of permanent magnets formed from a magnetised isotropic or anisotropic material.

71. The element as claimed in claim 70, comprising a second plurality of permanent magnets formed in the magnetised isotropic or anisotropic material.
